(19) United States
(12) Patent Application Publication
(10) Pub. No.: US 2026/0290699 A1
(43) Pub. Date: Sep. 24, 2026

(54) MULTILAYER ELECTRONIC COMPONENT

(71) Applicant: SAMSUNG ELECTRO-MECHANICS CO., LTD., Suwon-si (KR)

(72) Inventors: Ji Young LEE, Suwon-si (KR); Jung Won PARK, Suwon-si (KR); Dong Jun JUNG, Suwon-si (KR); Yoo Jeong LEE, Suwon-si (KR)

(73) Assignee: SAMSUNG ELECTRO-MECHANICS CO., LTD., Suwon-si (KR)

(21) Appl. No.: 19/456,257

(22) Filed: Jan. 22, 2026

(30) Foreign Application Priority Data
Mar. 19, 2025 (KR) 10-2025-0035372

(51) Int. Cl. H01G 4/30; H01G 4/12

(52) U.S. Cl. CPC H01G 4/30; H01G 4/1227

(57) ABSTRACT

A circularity-dependent frequency of existence of a plurality of nanodomains BD and LD in a capacitance formation portion Ac is adjusted to have a maximum value in a range of circularity of 0.85 or more and 1.00 or less or the frequency of existence of the bubble domain BD having a circularity in a range of 0.85 or more and 1.00 or less is adjusted to 0.2 or more, thereby improving the capacitance per unit volume of a multilayer electronic component 100.

### CROSS-REFERENCE TO RELATED APPLICATION(S)

This application claims benefit of priority to Korean Patent Application No. 10-2025-0035372 filed on Mar. 19, 2025 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a type of multilayer electronic component, is a chip-shaped capacitor mounted on the printed circuit boards of various electronic devices, including display devices, such as liquid crystal displays (LCDs) and plasma display panels (PDPs), computers, smartphones, and mobile phones, to charge or discharge electricity therein or therefrom.

Such multilayer ceramic capacitors may be used as components in various electronic devices due to their compact size, high capacitance, and ease of mounting. As electronic devices, such as computers and mobile devices, have become smaller and more powerful, demand for miniaturized and high-capacitance multilayer ceramic capacitors has increased.

If dielectric layers are formed thinly to achieve miniaturization and high capacitance in multilayer ceramic capacitors, the reliability of the multilayer ceramic capacitors may be aggravated. To improve the reliability of multilayer ceramic capacitors, a method of forming small dielectric grains using a small BaTiO₃ base material may be used. However, this may have a negative effect of reducing the effective capacitance of multilayer ceramic capacitors.

Therefore, there is a need to improve the microstructure of dielectric layers so that the effective capacitance of multilayer ceramic capacitors does not decrease even when dielectric grains included in dielectric layers are formed to be small.

### RELATED ART DOCUMENT

### Patent Document

(Patent Document 1) WO 2013-146303 A1

### SUMMARY

An aspect of the present disclosure is to provide a multilayer electronic component with improved capacitance per unit volume.

Another aspect of the present disclosure is to provide a multilayer electronic component including a dielectric layer with improved dielectric properties by controlling a microstructure of a domain structure of a dielectric grain.

However, the problems to be solved by the present disclosure are not limited to the above-described contents and will be more readily understood when describing specific example embodiments of the present disclosure.

According to an aspect of the present disclosure, a multilayer electronic component includes: a body including a dielectric layer including a plurality of dielectric grains and a capacitance formation portion including internal electrodes alternately disposed with the dielectric layer; and external electrodes disposed on the body, wherein one or more of the plurality of dielectric grains include a plurality of nanodomains having a major diameter of 1 nm or more and less than 100 nm, the plurality of nanodomains include a plurality of bubble domains having a circularity of 0.85 or more and 1.00 or less, and a circularity-dependent frequency of existence of the plurality of nanodomains in the capacitance formation portion has a maximum value in a range in which the circularity is 0.85 or more and 1.00 or less.

According to another aspect of the present disclosure, a multilayer electronic component includes: a body including a dielectric layer including a plurality of dielectric grains and a capacitance formation portion including internal electrodes alternately disposed with the dielectric layer; and external electrodes disposed on the body, wherein one or more of the plurality of dielectric grains include a plurality of nanodomains having a major diameter of 1 nm or more and less than 100 nm, wherein the plurality of nanodomains include a plurality of bubble domains having a circularity of 0.85 or more and 1.00 or less, and wherein a frequency of existence of the bubble domains in the capacitance formation portion is 0.2 or more.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an example embodiment of the present disclosure;

FIG. 2 is an exploded perspective view schematically illustrating a stack structure of internal electrodes;

FIG. 3 is a cross-sectional view taken along line I-I′ of FIG. 1;

FIG. 4 is a cross-sectional view taken along line II-II′ of FIG. 1;

FIG. 5 is an enlarged view of region P of FIG. 3;

FIGS. 6A, 6B, and 6C schematically illustrate dielectric grains including nanodomains;

FIG. 7A is an image of a domain region measured using an AFM measurement device when an electric field is applied to a dielectric microstructure according to an example embodiment, FIG. 7B is a visualization of the image of FIG. 7A using an image processing program, and FIG. 7C is a graph illustrating the frequency of existence of domains according to circularity in a dielectric microstructure according to an example embodiment; and

FIG. 8A is an image of a domain region measured using an AFM measurement device when an electric field is applied to a dielectric microstructure according to an example embodiment, FIG. 8B is a visualization of the image of FIG. 8A using an image processing program, and FIG. 8C is a graph illustrating the frequency of existence of domains according to circularity in a dielectric microstructure according to an example embodiment.

### DETAILED DESCRIPTION

Hereinafter, exemplary example embodiments of the present inventive concept will be described in detail with reference to the accompanying drawings. The inventive concept may, however, be exemplified in many different forms and should not be construed as being limited to the specific exemplary example embodiments set forth herein. Rather, these exemplary example embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

Here and throughout the specification and claims, range limitations are combined and/or interchanged. Such ranges are identified and include all the sub-ranges contained therein unless context or language indicates otherwise. For example, all ranges disclosed herein are inclusive of the endpoints, and the endpoints are independently combinable with each other.

Approximating language, as used herein throughout the specification and claims, may be applied to modify any quantitative representation that could permissibly vary without resulting in a change in the basic function to which it is related. Accordingly, a value solidified by a term or terms, such as “about”, and “substantially” is not to be limited to the precise value specified.

In the drawings, the X-direction may refer to a first direction or a thickness direction, the Y-direction to a second direction or a length direction, and the Z-direction to a third direction or a width direction. A stacking direction of the internal electrodes 121 and 122 or the dielectric layer 111, which will be described herein, may be either the thickness direction or the width direction.

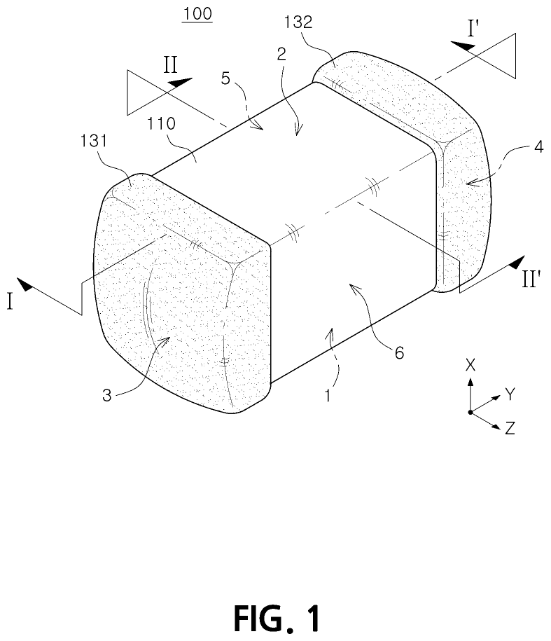

FIG. 1 is a perspective view schematically illustrating a multilayer electronic component according to an example embodiment of the present disclosure.

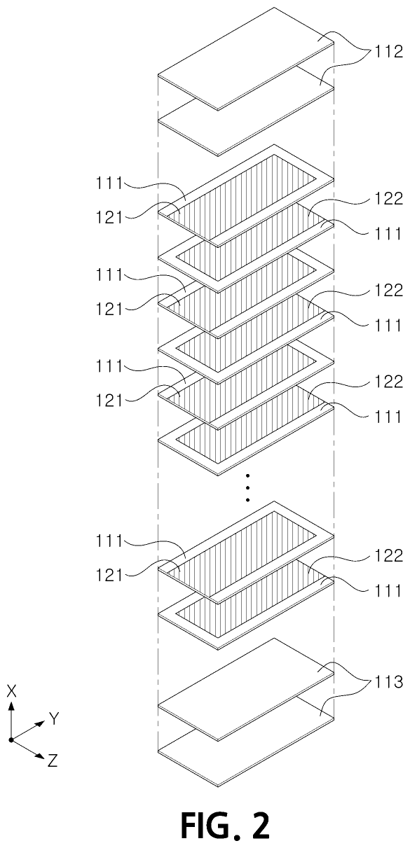

FIG. 2 is an exploded perspective view schematically illustrating a stack structure of internal electrodes.

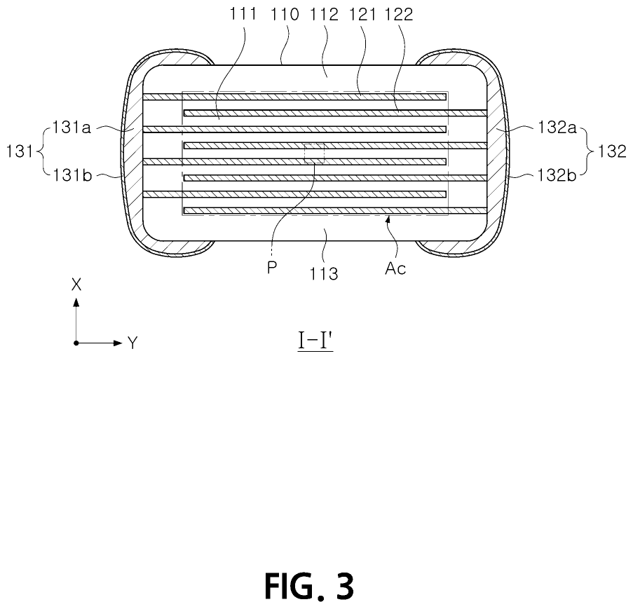

FIG. 3 is a cross-sectional view taken along line I-I′ of FIG. 1.

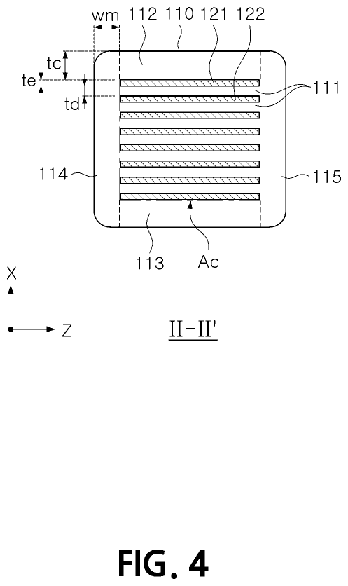

FIG. 4 is a cross-sectional view taken along line II-II′ of FIG. 1.

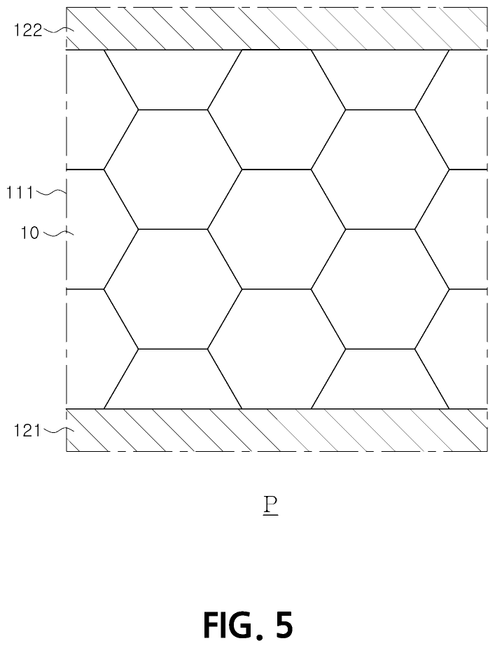

FIG. 5 is an enlarged view of region P of FIG. 3.

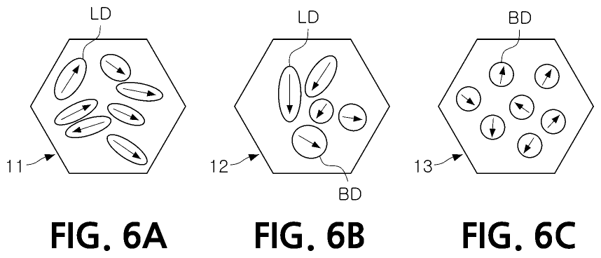

FIGS. 6A, 6B, and 6C schematically illustrate dielectric grains including nanodomains.

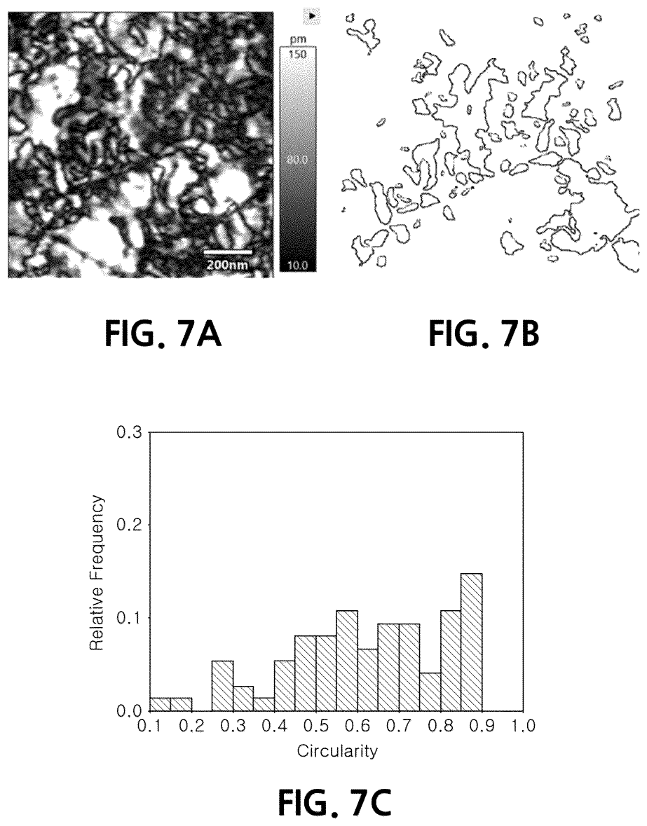

FIG. 7A is an image of a domain region measured using an AFM measurement device when an electric field is applied to a dielectric microstructure according to an example embodiment, FIG. 7B is a visualization of the image of FIG. 7A using an image processing program, and FIG. 7C is a graph illustrating the frequency of existence of domains according to circularity in a dielectric microstructure according to an example embodiment.

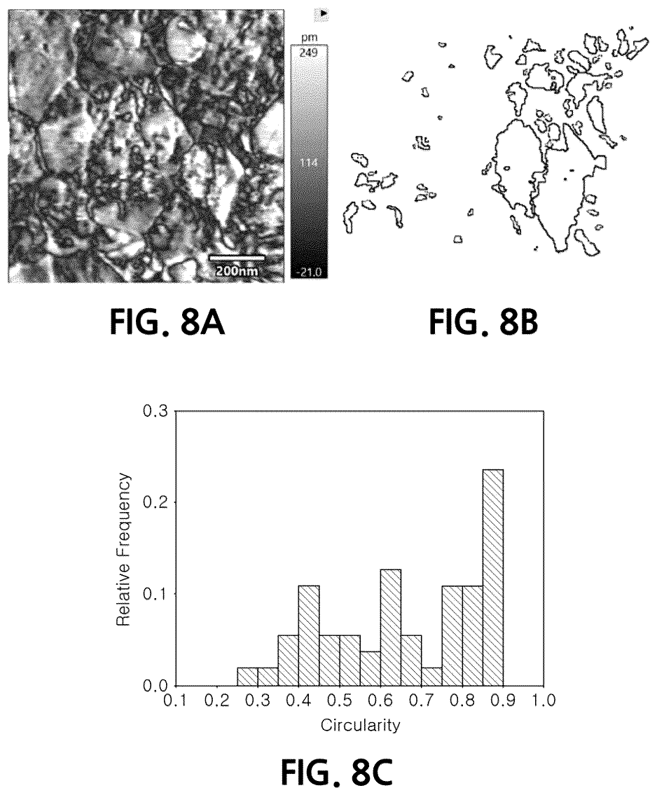

FIG. 8A is an image of a domain region measured using an AFM measurement device when an electric field is applied to a dielectric microstructure according to an example embodiment, FIG. 8B is a visualization of the image of FIG. 8A using an image processing program, and FIG. 8C is a graph illustrating the frequency of existence of domains according to circularity in a dielectric microstructure according to an example embodiment.

Hereinafter, a multilayer electronic component according to an example embodiment of the present disclosure and various example embodiments thereof will be described in detail with reference to FIGS. 1 through 8C. While a multilayer ceramic capacitor is described as an example of a multilayer electronic component, the present disclosure may also be applied to various electronic products utilizing dielectric compositions, such as inductors, piezoelectric devices, varistors, or thermistors.

According to an example embodiment of the present disclosure, a multilayer electronic component 100 may include a body 110 and external electrodes 131 and 132 disposed on the body 110. The body 110 may include a capacitance formation portion Ac and a dielectric layer 111. The capacitance formation portion Ac may include internal electrodes 121 and 122 alternately disposed with the dielectric layer 111. The dielectric layer 111 may include a plurality of dielectric grains 10. At least one of the plurality of dielectric grains 10 may include a plurality of nanodomains LD and BD. The plurality of nanodomains LD and BD may have a major diameter of 1 nm or more and less than 100 nm. The plurality of nanodomains LD and BD may include a plurality of bubble domains BD having a circularity of 0.85 or more and 1.00 or less. A circularity-dependent frequency of existence of the plurality of nanodomains LD and BD in the capacitance formation portion Ac may have a maximum value at a point at which the circularity is 0.85 or more and 1.00 or less.

According to an example embodiment of the present disclosure, the multilayer electronic component 100 may include the body 110 and the external electrodes 131 and 132 disposed on the body 110. The body 110 may include the capacitance formation portion Ac and the dielectric layer 111. The capacitance formation portion Ac may include the internal electrodes 121 and 122 alternately disposed with the dielectric layer 111. The dielectric layer 111 may include a plurality of dielectric grains 10. At least one of the plurality of dielectric grains 10 may include a plurality of nanodomains LD and BD having a major diameter of 1 nm or more and less than 100 nm. The plurality of nanodomains LD and BD may include a plurality of bubble domains BD having a circularity of 0.85 or more and 1.00 or less. The frequency of existence of bubble domains BD in the capacitance formation portion Ac may be 0.2 or more.

The body 110 may have the dielectric layer 111 and internal electrodes 121 and 122 that are alternately stacked.

More specifically, the body 110 may include the capacitance formation portion Ac disposed within the body 110 and forming capacitance by including the first internal electrode 121 and second internal electrode 122 alternately disposed to face each other with the dielectric layer 111 interposed therebetween.

While there are no specific limitations on the specific shape of the body 110, as illustrated, the body 110 may be formed in a hexahedral shape or a similar shape. Due to shrinkage of the ceramic particles included in the body 110 during a sintering process, the body 110 may not have a perfectly straight hexahedral shape but may have a substantially hexahedral shape.

The body 110 may have first and second surfaces 1 and 2 facing each other in a first direction, third and fourth surfaces 3 and 4 connected to the first and second surfaces 1 and 2 and facing each other in a second direction, and fifth and sixth surfaces 5 and 6 connected to the first to fourth surfaces 1, 2, 3, and 4 and facing each other in a third direction.

The plurality of dielectric layers 111 forming the body 110 are in a sintered state, and the boundaries between adjacent dielectric layers 111 may be integrated so that they are difficult to identify without a scanning electron microscope (SEM).

The raw material forming the dielectric layer 111 is not limited as long as sufficient capacitance may be obtained therewith. Generally, perovskite (ABO₃)-based materials may be used, such as barium titanate-based materials, lead-composite perovskite-based materials, or strontium titanate-based materials. The barium titanate-based materials may include BaTiO₃-based ceramic particles. Examples of ceramic particles include BaTiO3, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1), in which Ca (calcium), Zr (zirconium), etc. are partially dissolved in are BaTiO₃. In addition, the raw material forming the dielectric layer 111 may include particles of barium titanate (BaTiO₃) or the like, to which various ceramic additives, organic solvents, binders, dispersants, etc. may be added, depending on the purpose of the present disclosure.

Furthermore, since the dielectric layer 111 may be formed using a dielectric material, such as barium titanate (BaTiO₃), the dielectric layer 111 may include a dielectric microstructure after sintering. The dielectric microstructure may include a plurality of dielectric grains 10, dielectric grain boundaries disposed between adjacent dielectric grains 10, and dielectric triple points disposed at points at which three or more dielectric grain boundaries meet, and each may be provided in plural.

In the present disclosure, “domain region” may refer to a specific region in which the same polarization direction is concentrated, and “domain size” may refer to the major diameter passing through the center of the domain region as observed using domain (polarization) measurement equipment.

Domain regions may be observed using the following measurement equipment. Measurement equipment may be, but is not limited to, a measurement equipment or measurement mode capable of observing the domain regions, such as atomic force microscopy (AFM), piezoresponse force microscopy (PFM), scanning electron microscopy (SEM), transmission electron microscopy (TEM), scanning transmission electron microscopy (STEM), or polarization microscopy (PM).

Conventionally, to improve the reliability of multilayer electronic components, the size of dielectric grains may be reduced by using a small BaTiO₃-based substrate. In this case, the effective capacitance of the multilayer electronic component may be reduced. Meanwhile, Patent Document 1 introduces a dielectric material including nanodomains and describes a dielectric layer having a high relative permittivity even at high temperatures by adjusting the major diameter of the nanodomains. However, Patent Document 1 does not describe how dielectric properties may be altered by adjusting specific shapes, such as the circularity of nanodomains, or by adjusting the frequency of existence of highly circular nanodomains.

Meanwhile, at least one of the plurality of grains 10 included in the dielectric layer 111 includes a plurality of nanodomains LD and BD having a major diameter of 1 nm or more and less than 100 nm, and the plurality of nanodomains LD and BD may include a plurality of bubble domains BD having a circularity of 0.85 or more and 1.00 or less. The circularity-dependent frequency of existence of the plurality of nanodomains BD and LD in the capacitance formation portion Ac may have a maximum value within a range in which the circularity is 0.85 or more and 1.00 or less.

According to an example embodiment of the present disclosure, the bubble domain BD having a circularity of 0.85 or more and 1.00 or less has a higher piezoelectric coefficient d₃₃, which represents the degree of electrical polarization induced in the same direction when pressure is applied in a direction perpendicular to a piezoelectric material, compared to a nanodomain (labyrinthine domain LD) having a circularity less than 0.85. Therefore, the dielectric properties of the bubble domain BD having a circularity of 0.85 or more and 1.00 or less, which has a high piezoelectric coefficient d₃₃, may be considered superior to those of a nanodomain (labyrinthine domain LD) having a circularity less than 0.85.

However, even if the nanodomains LD and BD included in the dielectric layer 111 simply includes the bubble domain BD having a circularity of 0.85 or more and 1.00 or less, the capacitance per unit volume of the multilayer electronic component 100 may not be significantly improved.

Thus, in an example embodiment of the present disclosure, the circularity-dependent frequency of existence of a plurality of nanodomains BD and LD in the capacitance formation portion Ac is adjusted to have a maximum value in a range in which the circularity is 0.85 or more and 1.00 or less, or the frequency of existence of the bubble domain BD having a circularity of 0.85 or more and 1.00 or less is adjusted to 0.2 or more, thereby significantly improving the capacitance per unit volume of the multilayer electronic component 100. Accordingly, even when a nanodomain LD having a circularity less than 0.85 exists in the dielectric layer 111, the capacitance per unit volume of the multilayer electronic component 100 may be improved by the excellent dielectric properties of the bubble domain BD.

In the present disclosure, the “frequency of existence” by circularity of the nanodomains LD and BD may refer to the relative frequency representing the proportion of individuals with a specific circularity value relative to the total number of individuals.

Referring to FIG. 5, the dielectric layer 111 may include grain boundaries between the dielectric grains 10. Also, referring to FIGS. 6A to 6C, the dielectric grains 10 included in the dielectric layer 111 may include one or more of the dielectric grains 11, 12, and 13, each of which includes one or more of the labyrinthine domains LD and the bubble domains BD. In the present disclosure, the “nanodomains LD and BD” may be observed as a region in which the dielectric grains 10 are disposed in a certain polarization direction when the dielectric grains 10 are observed by applying a certain voltage at a certain frequency using an atomic force microscope (AFM). Among a plurality of domains, a domain region having a major diameter of 1 nm or more and less than 100 nm may be considered the nanodomains LD and BD. In addition, the nanodomains LD and BD of the present disclosure may be classified into a labyrinthine domain LD and a bubble domain BD according to circularity. Specifically, the bubble domain BD according to an example embodiment of the present disclosure may refer to a nanodomain having a circularity of 0.85 or more and 1.00 or less, and the labyrinthine domain may refer to a nanodomain having a circularity greater than 0 and less than 0.85.

Meanwhile, the labyrinthine domain LD and bubble domain BD of the present disclosure may refer to a specific region in which the same polarization direction is concentrated in the dielectric material forming the dielectric layer 111; thus, each may include a BaTiO₃-based material as a main component. Here, including a BaTiO₃-based material as a “main component” may refer to a case in which the mole fraction of the BaTiO₃-based material included in the respective domain is 0.5 or greater, but is not limited thereto.

The circularity-dependent frequency of existence of the plurality of nanodomains BD and LD in the capacitance formation portion Ac of the present disclosure may be measured by applying a drive amplitude of 1 V to a 1 μm×1 μm region in the center of the capacitance formation portion Ac of a first and second directional cross-section of the multilayer electronic component 100 polished to a third-directional half-point in a direction perpendicular to a cross-sectional area using DART lateral PFM mode, Asyelec.01-R2 cantilever of an atomic force microscope (AFM). The region in which nanodomains are formed may be measured using a frequency of 650 kHz in the lateral PFM mode in a direction parallel to the internal electrodes 121 and 122. In the PFM mode, a distribution of domains and domain walls in a sample may be checked with amplitude information, and information on a polarization direction may be checked with phase information. Using an image processing program, the major diameter, perimeter, and area of each nanodomain may be measured, and the circularity-dependent frequency of existence of the nanodomains LD and BD may be calculated. Meanwhile, the circularity of the nanodomains LD and BD of the present disclosure may be obtained using Equation 1 below:

$$Circularity = \frac{4 π \times area}{{( perimeter )}^{2}}$$

Meanwhile, a method for controlling the circularity-dependent frequency of existence of the nanodomains LD and BD of the present disclosure is not particularly limited. However, when a sample with an electrode layer and a plating layer applied to a body is subjected to different heat treatment temperatures, the circularity-dependent frequency of existence of the nanodomains LD and BD may be adjusted. Specifically, when heat treatment is performed at a low temperature of 160° C. or lower for 1 hour, the frequency of existence of labyrinthine domains LD with a circularity less than 0.85 may be increased, and when heat treatment is performed at a high temperature of 300° C. or higher for 1 hour, the frequency of existence of bubble domains BD with a circularity of 0.85 or higher may be increased.

The frequency of existence of bubble domains BD in the capacitance formation portion Ac exceeding a characteristic value may be advantageous in improving the dielectric properties of the dielectric layer 111 and enhancing the capacitance per unit volume of the multilayer electronic component 100.

Specifically, in an example embodiment, the frequency of existence of bubble domains BD in the capacitance formation portion Ac may be 0.2 or greater, and accordingly, even when labyrinthine domains LD with a circularity less than 0.85 are present in the dielectric layer 111, the capacitance per unit volume of the multilayer electronic component 100 may be further improved by the excellent dielectric properties of the bubble domains BD.

Meanwhile, in an example embodiment, when the frequency of existence of bubble domains BD in the capacitance formation portion Ac is 0.24 or greater, the capacitance per unit volume may be improved by 4.7% or greater, compared to when the frequency of existence of bubble domains BD in the capacitance formation portion Ac is less than 0.20.

Meanwhile, even if the circularity-dependent frequency of existence of the plurality of nanodomains LD and BD in the capacitance formation portion Ac does not have a maximum value within a range in which the circularity is 0.85 to 1.00, the capacitance per unit volume of the multilayer electronic component 100 may be improved to some extent if the frequency of existence of bubble domains BD is 0.2 or higher, and this effect may be further enhanced when the frequency of existence of bubble domains BD in the capacitance formation portion Ac is 0.24 or higher.

The dielectric layer 111 may include a plurality of dielectric grains 10, and in an example embodiment, the average size of the plurality of dielectric grains 10 may be in a range from 200 nm to 400 nm. Accordingly, the expression of nanodomains LD and BD within the dielectric grains 10 may be facilitated, and the effect of improving the capacitance per unit volume of the multilayer electronic component 100 may be enhanced by adjusting the circularity-dependent frequency of existence of the plurality of nanodomains BD and LD in the capacitance formation portion Ac to a maximum value within a range in which the circularity is 0.85 to 1.00.

The average size of the plurality of dielectric grains 10 included in the dielectric layer 111 may refer to the average diameter of the plurality of dielectric grains 10 observed in a corresponding region when the first and second directional cross-section in the third-directional center of the body 110 is observed by using a scanning electron microscope (SEM) or atomic force microscope (AFM). Here, the diameter of the dielectric grains 10 may correspond to a diameter calculated using an image processing program. For example, the diameter of one dielectric grain 10 may be an average value of the major and minor diameters passing through the center of the single dielectric grain 10. After obtaining the diameter of each dielectric grain 10 in this manner, the diameters of a plurality of dielectric grains 10 may be averaged again to obtain the average diameter of the plurality of dielectric grains 10, and the average diameter may be referred to as the average diameter of the plurality of dielectric grains 10.

A thickness td of the dielectric layer 111 is not particularly limited. For example, the average thickness td of one or more of the plurality of dielectric layers 111 may be 4 μm or less.

However, to facilitate miniaturization and high capacitance of the multilayer electronic component 100, the thickness of the dielectric layer 111 may be 0.6 μm or less, more preferably 0.4 μm or less.

Here, the thickness td of the dielectric layer 111 may refer to the thickness td of the dielectric layer 111 disposed between the first and second internal electrodes 121 and 122.

Meanwhile, the thickness td of the dielectric layer 111 may refer to the first-directional size of the dielectric layer 111. Furthermore, the thickness td of the dielectric layer 111 may refer to the average thickness td of the dielectric layer 111 and may refer to the first-directional average size of the dielectric layer 111.

The first-directional average size of the dielectric layer 111 may be measured by scanning the first and second-directional cross-section of the body 110 using a scanning electron microscope (SEM) at 10,000× magnification. More specifically, the first-directional average size of one dielectric layer 111 may refer to an average value calculated by measuring the first-directional sizes at five or more equally spaced points in the second direction of the single dielectric layer 111 in a scanned image. The five or more equally spaced points may be designated in the capacitance formation portion Ac. Also, by extending the average value measurement to five or more dielectric layers 111 and measuring the average value, the first-directional average size of the dielectric layer 111 may be further generalized.

Referring to FIG. 2, the internal electrodes 121 and 122 may be alternately stacked with the dielectric layer 111.

The internal electrodes 121 and 122 may include a first internal electrode 121 and a second internal electrode 122. The first and second internal electrodes 121 and 122 are alternately disposed to face each other with the dielectric layer 111 forming the body 110 interposed therebetween and may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body 110 and connected to the first internal electrode 121. A second external electrode 132 may be disposed on the fourth surface 4 of the body 110 and connected to the second internal electrode 122.

That is, referring to FIG. 3, the first internal electrode 121 may be connected to the first external electrode 131 without being connected to the second external electrode 132, and the second internal electrode 122 may be connected to the second external electrode 132 without being connected to the first external electrode 131. In this case, the first and second internal electrodes 121 and 122 may be electrically separated from each other by the dielectric layer 111 disposed therebetween.

Meanwhile, the body 110 may be formed by alternately stacking ceramic green sheets printed with the first internal electrode 121 and ceramic green sheets printed with the second internal electrode 122 and sintering the ceramic green sheets.

The material forming the internal electrodes 121 and 122 is not particularly limited, and any material with excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing a conductive paste for internal electrodes including one or more of nickel (Ni), copper (Cu), palladium (Pd), silver (Ag), gold (Au), platinum (Pt), tin (Sn), tungsten (W), titanium (Ti), and alloys thereof onto a ceramic green sheet. The conductive paste for internal electrodes may be printed using screen-printing or gravure printing, but the present disclosure is not limited thereto.

Meanwhile, a thickness the of the internal electrodes 121 and 122 need not be particularly limited.

However, to facilitate miniaturization and high capacitance of the multilayer electronic component, the thickness of the internal electrodes 121 and 122 may be 0.6 μm or less, more preferably 0.4 μm or less.

Here, the thickness the of the internal electrodes 121 and 122 may refer to the first-directional size of the internal electrodes 121 and 122. Also, the thickness the of the internal electrodes 121 and 122 may refer to the average thickness the of the internal electrodes 121 and 122 and may refer to the first-directional average size of the internal electrodes 121 and 122.

The first-directional average size of the internal electrodes 121 and 122 may be measured by scanning the first and second-directional cross-section of the body 110 using a scanning electron microscope (SEM) at 10,000× magnification. More specifically, the first-directional average size of one internal electrode may be an average value calculated by measuring the first-directional size of one internal electrode at five or more equally spaced points in the second direction in the scanned image. The five or more equally spaced points may be designated in the capacitance formation portion Ac. Furthermore, by extending the average measurement to five or more internal electrodes 121 and 122, the first-directional average size of the internal electrodes 121 and 122 may be further generalized.

Meanwhile, referring to FIG. 3, the body 110 may include cover portions 112 and 113 disposed on both end surfaces of the capacitance formation portion Ac in the first direction.

Specifically, the body 110 may include a first cover portion 112 disposed on one surface of the capacitance formation portion Ac in the first direction and a second cover portion 113 disposed on the other surface of the capacitance formation portion Ac in the first direction. More specifically, the body 110 may include an upper cover portion 112 disposed above the capacitance formation portion Ac in the first direction and a lower cover portion 113 disposed below the capacitance formation portion Ac in the first direction.

The upper cover portion 112 and lower cover portion 113 may be formed by stacking one dielectric layer 111 or two or more dielectric layers 111 on the upper and lower surfaces of the capacitance formation portion Ac in the first direction, respectively, and may fundamentally prevent damage to the internal electrodes 121 and 122 due to physical or chemical stress.

The upper cover portion 112 and lower cover portion 113 may not include the internal electrodes 121 and 122 and may include the same material as that of the dielectric layer 111. That is, the upper cover portion 112 and lower cover portion 113 may include a ceramic material, for example, a barium titanate (BaTiO₃)-based ceramic material.

Meanwhile, a thickness tc of the cover portions 112 and 113 may not be particularly limited.

However, to more easily achieve miniaturization and high capacitance of the multilayer electronic component, the thickness tc of the cover portions 112 and 113 may be 100 μm or less, preferably 30 μm or less, and more preferably 20 μm or less for ultra-small products.

Here, the thickness tc of the cover portions 112 and 113 may refer to the size of the cover portions 112 and 113 in the first direction. Furthermore, the thickness tc of the cover portions 112 and 113 may refer to the average thickness tc of the cover portions 112 and 113 and may refer to the average size of the cover portions 112 and 113 in the first direction.

The average size of the cover portions 112 and 113 in the first direction may be measured by scanning the first and second-directional cross-section of the body 110 using a scanning electron microscope (SEM) at 10,000× magnification. More specifically, the average size may be calculated by measuring the first-directional size at 30 equally spaced points in the second direction in a scanned image of one cover portion.

In addition, the average size of the cover portion in the first direction, measured using the aforementioned method, may be substantially the same as the average size of the cover portion in the first direction in the first and third-directional cross-section of the body 110.

Meanwhile, referring to FIG. 4, margin portions 114 and 115 may be disposed on both end-surfaces of the body 110 in the third direction.

More specifically, the margin portions 114 and 115 may include a first margin portion 114 disposed on the fifth surface 5 of the body 110 and a second margin portion 115 disposed on the sixth surface 6. In other words, the margin portions 114 and 115 may be disposed on both end-surfaces of the body 110 in the third direction.

As illustrated, the margin portions 114 and 115 may refer to regions between both ends of the first and second internal electrodes 121 and 122 in the third direction and the boundary surface of the body 110, based on the first and third-directional cross-section of the body 110.

The margin portions 114 and 115 may fundamentally serve to prevent damage to the internal electrodes 121 and 122 due to physical or chemical stress.

The margin portions 114 and 115 may be formed by applying conductive paste to a ceramic green sheet, except for the regions in which the margin portions 114 and 115 are to be formed, to form the internal electrodes 121 and 122. To suppress a step difference due to the internal electrodes 121 and 122, the internal electrodes 121 and 122 may be cut so to be exposed to the fifth and sixth surfaces 5 and 6 of the body 110, and then, one dielectric layer 111 or two or more dielectric layers 111 may be stacked and formed on both end surfaces of the capacitance formation portion Ac in the third direction.

The first margin portion 114 and the second margin portion 115 may not include the internal electrodes 121 and 122 and may include the same material as that of the dielectric layer 111. That is, the first margin portion 114 and the second margin portion 115 may include a ceramic material, for example, a barium titanate (BaTiO₃)-based ceramic material.

Meanwhile, a width wm of the first and second margin portions 114 and 115 may not be particularly limited.

However, to facilitate miniaturization and high capacitance of the multilayer electronic component 100, the width wm of the first and second margin portions 114 and 115 may be 100 μm or less, preferably 30 μm or less, and more preferably 20 μm or less for ultra-small products.

Here, the width wm of the margin portions 114 and 115 may refer to the size of each of the margin portions 114 and 115 in the third direction. In addition, the width wm of the margin portions 114 and 115 may refer to the average width wm of the margin portions 114 and 115 and may refer to the average size of the margin portions 114 and 115 in the third direction.

The average size of the margin portions 114 and 115 in the third direction may be measured by scanning an image of a first and third-directional cross-section of the body 110 using a scanning electron microscope (SEM) at 10,000× magnification. More specifically, the average size may refer to an average value calculated by measuring the third-directional sizes at 10 equally spaced points in the first direction in a scanned image of one margin portion.

In an example embodiment of the present disclosure, the ceramic electronic component 100 is described as having a structure with two external electrodes 131 and 132. However, the number and shape of the external electrodes 131 and 132 may vary depending on the shape of the internal electrodes 121 and 122 or other purposes.

Referring to FIG. 1, the external electrodes 131 and 132 may be disposed on the body 110.

The external electrodes 131 and 132 may be disposed on the body 110 and connected to the internal electrodes 121 and 122.

More specifically, the external electrodes 131 and 132 may be disposed on the third and fourth surfaces 3 and 4 of the body 110, respectively, and may include first and second external electrodes 131 and 132 connected to the first and second internal electrodes 121 and 122, respectively. That is, the first external electrode 131 may be disposed on the third surface 3 of the body and connected to the first internal electrode 121, and the second external electrode 132 may be disposed on the fourth surface 4 of the body and connected to the second internal electrode 122.

Furthermore, the external electrodes 131 and 132 may be disposed to extend to portions of the first and second surfaces 1 and 2 of the body 110 or may be disposed to extend to portions of the fifth and sixth surfaces 5 and 6 of the body 110. That is, the first external electrode 131 may be disposed on portions of the first, second, fifth, and sixth surfaces 1, 2, 5, and 6 of the body 110 and on the third surface 3 of the body 110. The second external electrode 132 may be disposed on portions of the first, second, fifth, and sixth surfaces 1, 2, 5, and 6 of the body 110 and on the third surface 3 of the body 110.

The external electrodes 131 and 132 may be formed using any material having electrical conductivity, such as metal. The specific material may be determined based on electrical characteristics, structural stability, and other factors. Furthermore, the external electrodes may have a multilayer structure.

For example, the external electrodes 131 and 132 may include electrode layers 131a and 132a disposed on the body 110 and plating layers 131b and 132b disposed on the electrode layers 131a and 132a.

More specifically, the electrode layers 131a and 132a may be sintered electrodes including a conductive metal and glass or resin-based electrodes including a conductive metal and resin.

Also, the electrode layers 131a and 132a may be formed in a form in which sintered electrodes and resin-based electrodes are sequentially formed on the body 110.

Also, the electrode layers 131a and 132a may be formed by transferring a sheet including a conductive metal onto the body 110 or by transferring a sheet including a conductive metal onto a sintered electrode.

The conductive metal used in the electrode layers 131a and 132a is not particularly limited as long as it may be electrically connected to the internal electrodes 121 and 122 to form capacitance. For example, the conductive metal may include one or more selected from the group consisting of nickel (Ni), copper (Cu), palladium (Pd), silver (Ag), gold (Au), platinum (Pt), tin (Sn), tungsten (W), titanium (Ti), and alloys thereof. The electrode layers 131a and 132a may be formed by applying a conductive paste prepared by adding glass frit to the conductive metal particles and then sintering the conductive paste.

The plating layers 131b and 132b may improve mounting characteristics. The type of plating layers 131b and 132b is not particularly limited and may be the plating layer 131b and 132b, each as a single layer, including one or more of nickel (Ni), tin (Sn), silver (Ag), palladium (Pd), and alloys thereof or may be formed as a plurality of layers.

In a specific example, the plating layers 131b and 132b may be a nickel plating layer or a tin plating layer. The nickel plating layer and the tin plating layer may be sequentially formed on the electrode layers 131a and 132a, or a tin plating layer, a nickel plating layer, and a tin plating layer may be sequentially formed. Furthermore, the plating layers 131b and 132b may include a plurality of nickel plating layers and/or a plurality of tin plating layers.

The size of the multilayer electronic component 100 is not particularly limited.

However, in order to achieve both miniaturization and high capacitance, the thickness of the dielectric layer and the internal electrode should be thinned to increase the number of layers, so the effect according to the present disclosure may be more noticeable in the multilayer electronic component 100 having the size 1005 (length×width: 1.0 mm×0.5 mm, the error range of length and width is within +5%) or the size 0603 (length×width: 0.6 mm×0.3 mm, the error range of length and width is within +5%) or smaller.

Hereinafter, the present disclosure will be described in more detail through experimental examples. However, these examples are intended to facilitate a more concrete understanding of the present disclosure and are not intended to limit the scope of the present disclosure.

### Experimental Examples

[Table 1] shows comparison between the capacitance of multilayer electronic component samples according to the frequency of existence of bubble domains BD with a circularity of 0.85 or greater and 1.00 or less.

FIG. 7A is an image of a domain region measured using an AFM measurement device when an electric field is applied to a dielectric microstructure according to an example embodiment, FIG. 7B is a visualization of the image of FIG. 7A using an image processing program, and FIG. 7C is a graph illustrating the frequency of existence of domains according to circularity in a dielectric microstructure according to an example embodiment.

FIG. 8A is an image of a domain region measured using an AFM measurement device when an electric field is applied to a dielectric microstructure according to an example embodiment, FIG. 8B is a visualization of the image of FIG. 8A using an image processing program, and FIG. 8C is a graph illustrating the frequency of existence of domains according to circularity in a dielectric microstructure according to an example embodiment

The frequency of existence of bubble domains was measured by applying a drive amplitude of 1 V to a 1 μm×1 μm region in the center of the capacitance formation portion of a first and second directional cross-section of the multilayer electronic component 100 polished to a third-directional half-point in a direction perpendicular to a cross-sectional area using DART lateral PFM mode, Asyelec.01-R2 cantilever of an atomic force microscope (AFM). The region in which nanodomains are formed was measured using a frequency of 650 kHz in the lateral PFM mode in a direction parallel to the internal electrodes 121 and 122. In the PFM mode, a distribution of domains and domain walls in a sample was checked with amplitude information, and information on a polarization direction was checked with phase information. Using an image processing program, the major diameter, perimeter, and area of each nanodomain were measured, and the circularity-dependent frequency of existence of the nanodomains LD and BD was calculated. The average value for one sample was calculated and presented in [Table 1].

The effective capacitance of the multilayer electronic components for each test number was calculated from the average value of the capacitance measured for one sample at 1 kHz, 1.0 V, and 25° C. and presented in [Table 1].

TABLE 1

| | Effective capacitance | Frequency of existence of bubble |
|---|---|---|
| Test No. | (μF) | domain |
| 1 | 2.33 | 0.14 |
| 2 | 2.44 | 0.24 |

The sample was manufactured as follows.

First, ceramic powder for forming a dielectric layer was prepared. BaTiO₃-based ceramic powder was used.

Next, the prepared ceramic powder was dried and ground, then mixed with an organic solvent, such as ethanol, and a dispersant to produce a slurry, which was milled for 1 to 30 hours. A binder, such as polyvinyl butyral, was then added to the slurry and further milled for 1 to 15 hours. The prepared slurry was applied onto a carrier film and dried to produce a ceramic green sheet.

Next, an internal electrode conductive paste including metal powder, binder, organic solvent, etc., was screen-printed onto the ceramic green sheet to a predetermined thickness to form an internal electrode pattern. The ceramic green sheet with the internal electrode pattern printed thereon was then peeled from the carrier film, and a predetermined number of layers of ceramic green sheets with the internal electrode pattern printed thereon were stacked and compressed together to form a ceramic stack.

The ceramic stack was then cut into a predetermined chip size, and the cut chips were sintered to form a body. The sintering was performed, for example, in a 1.0% H₂/99.0% N₂ to 3.5% H₂/96.5% N₂ (H₂O/H₂/N₂) atmosphere at a temperature of 1000° C. to 1400° C. for 2 hours.

Thereafter, the body was dipped into an external electrode conductive paste including metal powder, glass frit, a binder, and an organic solvent, and then, the external electrode conductive paste was sintered at a temperature of 500° C. to 900° C. to form a sintered electrode layer.

Subsequently, electroplating was additionally performed to form a plating layer.

The sample of the multilayer electronic component with the plating layer was subjected to separate heat treatment to adjust the frequency of existence of nanodomains. Test No. 1 was performed at a temperature of 160° C. or lower for 1 hour, and Test No. 2 was performed at a temperature of 300° C. or higher for 1 hour.

Referring to Table 1, it may be confirmed that Test No. 2, in which the frequency of existence of bubble domains is 0.24, achieved approximately 4.7% higher effective capacitance of the multilayer electronic component than Test No. 1, in which the frequency of existence of bubble domains is 0.14. In other words, it may be confirmed that the effective capacitance of the multilayer electronic component is improved as the frequency of existence of bubble domains increases.

One of the various effects of the present disclosure is to improve the capacitance per unit volume of the multilayer electronic component.

One of the various effects of the present disclosure is to provide the multilayer electronic component including the dielectric layer with improved dielectric properties by controlling the microstructure of the domain structure of the dielectric grains.

However, the various advantageous advantages and effects of the present disclosure are not limited to the above-described content and will be more readily understood through the description of specific example embodiments of the present disclosure.

Although the example embodiments or experimental examples of the present disclosure have been described in detail above, the present disclosure is not limited to the example embodiments described above and the accompanying drawings but is intended to be limited by the appended claims. Accordingly, various forms of substitution, modification, and change may be made by those skilled in the art within the scope without departing from the technical idea of the present disclosure described in the claims, and this will also be considered to fall within the scope of the present disclosure.

The expression “an example embodiment or an example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

The terms used herein are for the purpose of describing particular example embodiments only and are not intended to limit the example embodiments. As used herein, the singular forms “a,” “an,” and “the” are intended to include the plural forms as well, unless the context clearly indicates otherwise.

What is claimed is:

1. A multilayer electronic component comprising:
a body including:
a dielectric layer including a plurality of dielectric grains, and
a capacitance formation portion including internal electrodes alternately disposed with the dielectric layer; and
external electrodes disposed on the body,
wherein one or more of the plurality of dielectric grains include a plurality of nanodomains having a major diameter of 1 nm or more and less than 100 nm, the plurality of nanodomains include a plurality of bubble domains having a circularity of 0.85 or more and 1.00 or less, and
a circularity-dependent frequency of existence of the plurality of nanodomains in the capacitance formation portion has a maximum value in a range in which the circularity is 0.85 or more and 1.00 or less.

2. The multilayer electronic component according to claim 1, wherein the frequency of existence of the bubble domain in the capacitance formation portion is 0.2 or more.

3. The multilayer electronic component according to claim 1, wherein the frequency of existence of the bubble domain in the capacitance formation portion is 0.24 or more.

4. The multilayer electronic component according to claim 1, wherein the bubble domain includes BaTiO₃-based material as a main component.

5. The multilayer electronic component according to claim 1, wherein the dielectric layer includes BaTiO₃-based material as a main component.

6. The multilayer electronic component according to claim 1, wherein an average size of the plurality of dielectric grains is 200 nm or more and 400 nm or less.

7. The multilayer electronic component according to claim 1, wherein an average thickness of one or more of the plurality of dielectric layers is 4 μm or less.

8. A multilayer electronic component comprising:
a body including:
a dielectric layer including a plurality of dielectric grains, and
a capacitance formation portion including internal electrodes alternately disposed with the dielectric layer; and
external electrodes disposed on the body,
wherein one or more of the plurality of dielectric grains include a plurality of nanodomains having a major diameter of 1 nm or more and less than 100 nm,
wherein the plurality of nanodomains include a plurality of bubble domains having a circularity of 0.85 or more and 1.00 or less, and
wherein a frequency of existence of the bubble domains in the capacitance formation portion is 0.2 or more.

9. The multilayer electronic component according to claim 8, wherein the frequency of existence of the bubble domain in the capacitance formation portion is 0.24 or more.

10. The multilayer electronic component according to claim 8, wherein the bubble domain includes a BaTiO₃-based material as a main component.

11. The multilayer electronic component according to claim 8, wherein the dielectric layer includes a BaTiO₃-based material as a main component.

12. The multilayer electronic component according to claim 8, wherein an average size of the plurality of dielectric grains is 200 nm or more and 400 nm or less.

13. The multilayer electronic component according to claim 8, wherein an average thickness of one or more of the plurality of dielectric layers is 4 μm or less.
